(19) United States
(12) Patent Application Publication
(10) Pub. No.: US 2008/0001592 A1
(43) Pub. Date: Jan. 3, 2008

(54) METHOD FOR GENERATING A REFERENCE CURRENT AND A RELATED FEEDBACK GENERATOR

(75) Inventors: Antonino CONTE, Tremestieri Etneo (IT); Mario Micciche, Agrigento (IT); Vittorio Scavo, Acireale (IT); Roberto Rosario Grasso, Acicastello (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 11/763,679

(22) Filed: Jun. 15, 2007

(30) Foreign Application Priority Data
Jun. 16, 2006 (IT) VA2006A000034

(51) Int. Cl. G05F 3/20

(52) U.S. Cl. 323/316

(57) ABSTRACT

A feedback generator of a reference current may include a differential amplifier having a first input for a reference voltage, and a second input for a feedback voltage and generating an output voltage. The feedback generator may also include a first conduction path including a feedback resistor with the feedback voltage applied thereon, and a first transistor controlled by the output voltage and forcing through the feedback resistor the reference current. The feedback generator may also include a second conduction path coupled to the differential amplifier and biasing the differential amplifier based upon the reference current.

### FIELD OF THE INVENTION

This invention relates to a current generator and, more particularly, to a generator of a constant reference current.

### BACKGROUND OF THE INVENTION

Current generators employing active devices are commonly used in integrated analog circuits as biasing elements, active loads in amplification stages, and other similar applications. The use of current generators as biasing elements may be useful for fabricating circuits with performance that is substantially independent of fluctuations of the supply voltage and of temperature. The most frequently used parameters for evaluating performances of a current generator are sensitivity to supply voltage and sensitivity to temperature.

Another parameter for evaluating the performance of a current generator is rejection of wide frequency spectrum noise that is often present on supply lines, being caused by, for example, digital circuits, oscillators, charge pumps, and similar circuits connected to the same supply line. In many applications, stable reference currents are generated from a constant voltage reference, such as, for example, a bandgap generator. This approach may obtain a reference current that remains substantially constant when the supply voltage and temperature fluctuate, because the bandgap generator has such characteristics.

A possible scheme for generating a reference current is depicted in FIG. 1. Eventual variations of the current depend on the fact that the resistance varies with temperature. Through an appropriate design of the circuit, it is possible to compensate for thermal variations of the resistance and obtain a reference current that is practically constant within a broad range of temperatures.

As may be observed from FIG. 1, the operational amplifier biases the feedback voltage node Resnet to the bandgap reference voltage V_bg and generates an output voltage Vout1 such as to force through the transistor M4 a current equal to V_bg/R4. In order to ensure a small offset between the two inputs of the operational amplifier, a differential amplifier of relatively large gain may be used. However, this design increases stability problems and uses an effective compensation network (capacitance and resistance) with a consequent increase of silicon area occupation.

### SUMMARY OF THE INVENTION

This invention may provide a reference current generator with good performance in terms of insensitivity to fluctuations in the supply voltage, noise rejection in the supply voltage, stability, and insensitivity to temperature variations. Moreover, this current generator may occupy less silicon area than known generators with similar performance.

This current reference generator may comprise a differential amplifier that is input with a band-gap reference voltage and a feedback voltage and generates an output voltage applied on a feedback resistor, through which the reference current is forced. According to this reference current, the generator may have an additional second conduction path that replicates the reference current that flows through the feedback resistor and biases with such a replica current the differential amplifier.

According to a method for generating a constant reference current, the transistors of the differential amplifier may be biased with a scaled or amplified or identical replica of the current that flows in the feedback resistor. Therefore, eventual systematic offsets of the current Iref caused by differences between the two input nodes of the operational amplifier may be canceled.

### BRIEF DESCRIPTION OF THE DRAWINGS

An embodiment of this invention is illustrated in detail in the attached drawings, wherein:

FIG. 1 illustrates a constant reference current generator according to the prior art;

FIG. 2 illustrates an embodiment of a constant reference current generator according to the present invention;

FIG. 3 illustrates a Bode diagram of the Power Supply Rejection Ratio (PSRR) of the voltage Viref of the generator of FIG. 2, according to the present invention; and

FIG. 4 illustrates the Bode diagrams of the module and of the phase of the output voltage of the amplifier of the generator of FIG. 2, according to the present invention.

### DETAILED DESCRIPTION OF THE PREFERRED EMBODIMENTS

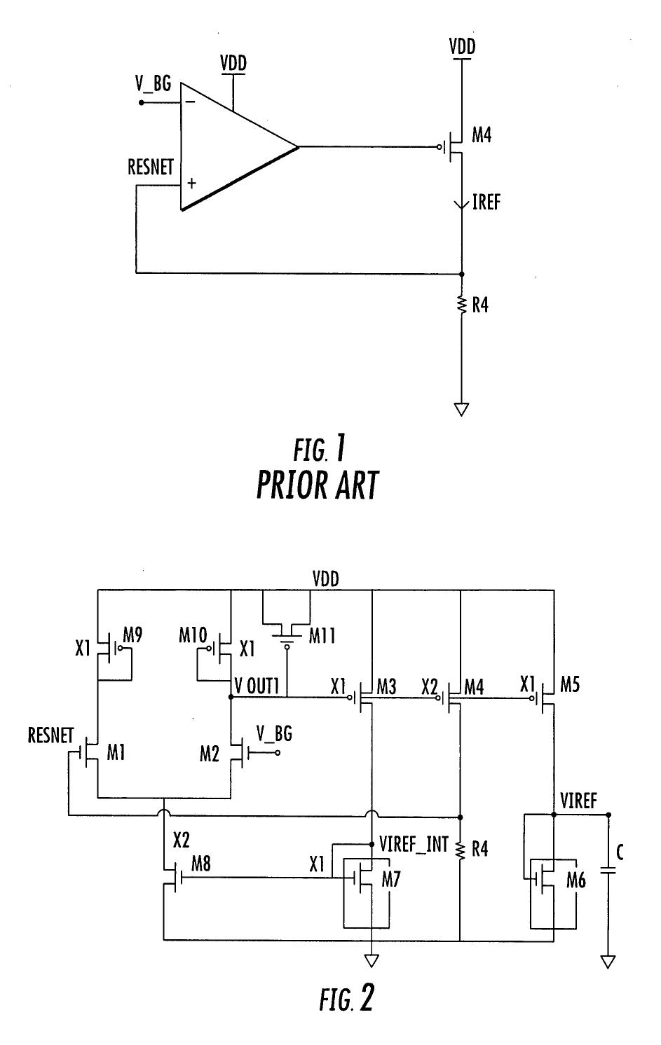

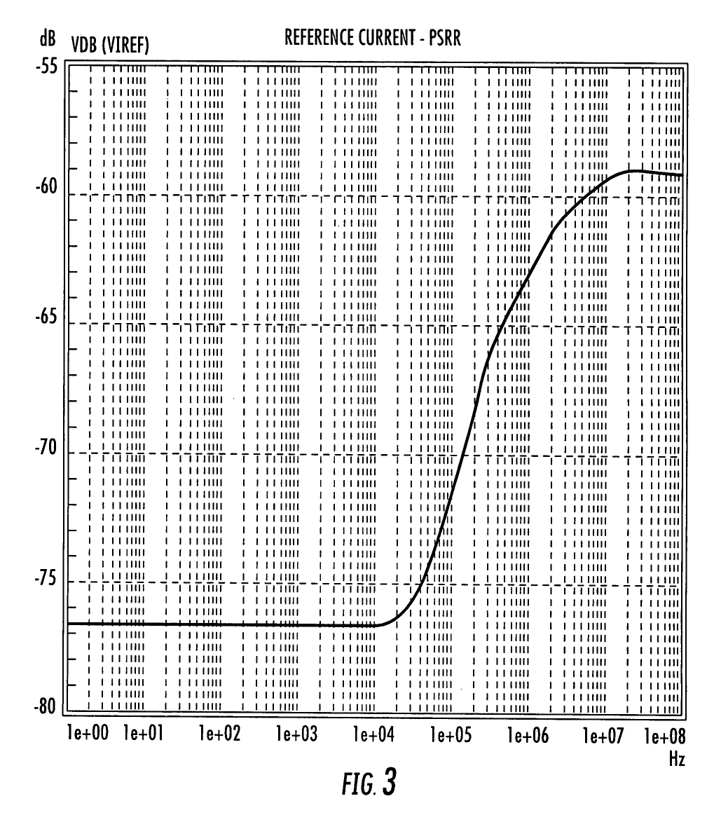

Referring to the circuit diagram of a constant current generator depicted in FIG. 2, as in the prior art diagram of FIG. 1, it comprises a differential amplifier that is input with the bandgap reference voltage V_bg and the feedback voltage Resnet. A transistor M4 is controlled by the output voltage Vout1 connected in series with a feedback resistor R4, in which the reference current Iref flows and on which the feedback voltage Resnet is produced.

The illustration of FIG. 2 includes a second current path for biasing the differential amplifier with either a scaled/amplified or identical replica of the current Iref flowing through the resistor R4. According to this embodiment of the amplifier, this is done by the transistor M3 and the diode-connected transistor M7 forming a current mirror with the bias transistor MS of the differential amplifier. The transistor M3 may be a scaled replica of the transistor M4 and is controlled by the output voltage Vout1. As a consequence, the current that flows in the transistor M3 is a scaled replica of the reference current Iref that flows in the transistor M4 because these two transistors are biased exactly in the same way.

The transistor M7 provides a current mirror with the transistor MS, that biases the differential amplifier with a scaled or amplified or identical replica (depending on the dimensions of the transistors M3, M4, M7, and M8) of the reference current Iref. Conveniently, as illustrated in FIG. 2, the transistor M3 may be a replica of the transistor M4, scaled by a factor 2, and the current mirror M7, M8 has a mirror ratio equal to 2, thus the differential amplifier is biased exactly with the current Iref. Therefore, the transistors M3 and M7 may be smaller than the transistors M4 and M8 and occupy a reduced silicon area.

A person of ordinary skill in the art may recognize immediately that, if the differential amplifier is biased exactly with the reference current Iref, it is possible to choose also a transistor M3 identical to the transistor M4 and make the current ratio of the mirror M7, M8 equal to 1. By choosing different dimensions of the transistors M3 and M7, the bias current of the operational amplifier may either be a scaled/amplified or identical replica of the reference current.

The circuit illustrated in FIG. 2 may keep the voltage on the resistor R4 (Resnet) constantly at the reference voltage V_bg in all working conditions. Indeed, through the two branches of the amplifier flow always half of the bias current because it is not used to unbalance the input nodes of the differential amplifier and to allow a different subdivision of the current in the two branches for balancing eventual fluctuations of the reference current. For the known generator of FIG. 1, if the generated current differs from that used for biasing the operational amplifier, the latter may asymmetrically divide the bias current in the two branches, thus unbalancing the two input nodes. In order to keep the voltages on the two input nodes as close as possible, a high gain amplifier may be used.

By contrast, in this differential amplifier, it may not be necessary to have a very large gain because the current Iref remains constant and the voltage Resnet is practically equal to the reference voltage V_bg, as it is used also in the circuit of FIG. 1. A common low gain differential amplifier can be satisfactorily used. This greatly reduces stability problems to the point that it may become unnecessary to provide this embodiment of the current generator with a Miller network of compensation or other similar networks. This current generator may occupy a significantly smaller silicon area and may avail worsening the PSRR figure, generally a well known consequence when employing a Miller compensation network.

According to the embodiment illustrated in FIG. 2, a capacitive coupling is established between the node on which the output voltage Vout1 is produced and the supply line VDD of the generator. This capacitive coupling may be provided by means of a MOSFET controlled by the output voltage Vout1, the source and drain of which are shorted to the supply line. Therefore, eventual fluctuations of the gate-source voltage of the transistor M4 may be prevented from modulating the reference current Iref.

In the embodiment illustrated in FIG. 2, there is a third current path in parallel to the first and to the second paths, comprising a transistor M5 identical to the transistor M3 and controlled by the voltage Vout1, connected in series to a diode-connected transistor M6, for generating another scaled replica of the reference current. Optionally, in order to ground eventual high frequency components of the voltage Viref, a filtering capacitor C is connected as depicted in FIG. 2.

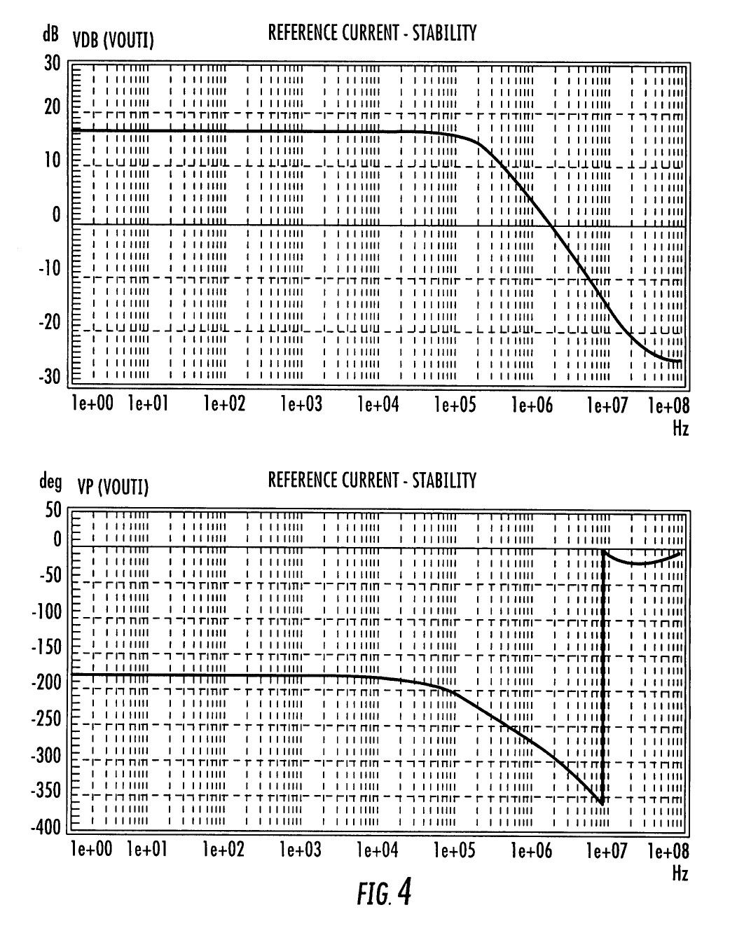

FIG. 3 is a Bode diagram of the PSRR of the current generator of FIG. 2, obtained with the following values of the resistor R4, of the capacitor C and with the MOSFETs having the following characteristics:
R4=420 kΩ; C=45 pF;
MOSFET in 0.18 μm technology:
M3, M5, M9, M10: W=8 μm, L=16 μm
M6, M7: W=4 μm, L=20 μm
M1, M2: W=10 μm, L=1 μm.

### As readily recognizable from the diagram of FIG. 3, the PSRR is very large and the noise conveyed through the supply line is significantly dampened (in the worst case) by about 59 dB, at the frequency of about 20 MHz.

FIG. 4 depicts the Bode diagrams in terms of modulus and of phase of the output voltage of the generator of FIG. 2 with the above indicated characteristics. The generator has a double pole at the frequency of about 200 kHz, which makes high frequency disturbances almost completely canceled. Moreover, the generator of FIG. 2 has an amplitude and phase margins of about 15 dB and 70°, that are amply sufficient to ensure stability in almost all working conditions.

This current generator may have the following important advantages: it may not have problems of stability and thus allows reductions of silicon area being occupied because a compensation network is no longer needed; it may strongly reduce eventual systematic offsets; and it may ensure a high noise rejection toward supply lines.

1-4. (canceled)

5. A feedback generator of a reference current comprising:
a differential amplifier having a first input for a reference voltage, and a second input for a feedback voltage and generating an output voltage;
a first conduction path comprising a feedback resistor with the feedback voltage applied thereon, and a first transistor controlled by the output voltage and forcing through said feedback resistor the reference current; and
a second conduction path biasing said differential amplifier based upon the reference current.

6. The feedback generator according to claim 5 wherein said second conduction path biases said differential amplifier with a scaled replica of the reference current.

7. The feedback generator according to claim 5 wherein said second conduction path biases said differential amplifier with an identical replica of the reference current.

8. The feedback generator according to claim 5 wherein said differential amplifier further comprises a bias transistor; and wherein said second conduction path is coupled in parallel to said first conduction path and comprises:
a second transistor controlled by the output voltage; and
a circuit element coupled in series with said second transistor;
said bias transistor being coupled to said circuit element to provide a current mirror.

9. The feedback generator according to claim 8 wherein said circuit element comprises at least one of a diode-connected transistor and a diode.

10. The feedback generator according to claim 5 further comprising:
a supply line; and
a filtering capacitive element coupled between an output of said differential amplifier and said supply line.

11. The feedback generator according to claim 10 wherein said filtering capacitive element comprises a transistor.

12. A feedback generator of a reference current comprising:
a differential amplifier having a first input for a reference voltage, and a second input for a feedback voltage and generating an output voltage;
a first conduction path comprising a feedback resistor with the feedback voltage applied thereon, and a first transistor controlled by the output voltage and forcing through said feedback resistor the reference current; and
a second conduction path biasing said differential amplifier with a replica of the reference current.

13. The feedback generator according to claim 12 further comprising:
a supply line; and
a filtering capacitive element coupled between an output of said differential amplifier and said supply line.

14. The feedback generator according to claim 13 wherein said filtering capacitive element comprises a transistor.

15. A method for generating a reference current with a differential amplifier generating an output voltage and comprising a first input for a reference voltage and a second input for a feedback voltage, the feedback voltage being produced on a first conduction path including a feedback resistor, the output voltage controlling a first transistor of the first conduction path, the first transistor applying to the feedback resistor the reference current, the method comprising:
biasing the differential amplifier based upon the reference current.

16. The method according to claim 15 wherein a conduction path biases the differential amplifier with a scaled replica of the reference current.

17. The method according to claim 15 wherein a conduction path biases the differential amplifier with an identical replica of the reference current.

18. The method according to claim 15 wherein a filtering capacitive element is coupled between an output of the differential amplifier and a supply line.

19. A method for generating a reference current with a differential amplifier comprising:
generating an output voltage at an output of the differential amplifier, the differential amplifier having a first input for a reference voltage and a second input for a feedback voltage;
generating the feedback voltage on a first conduction path comprising a resistor and a first transistor coupled thereto;
controlling the first transistor with the output voltage;
applying the reference current to the feedback resistor; and
biasing the differential amplifier based upon the reference current.

20. The method according to claim 19 wherein a conduction path biases the differential amplifier with a scaled replica of the reference current.

21. The method according to claim 19 wherein a conduction path biases the differential amplifier with an identical replica of the reference current.

22. The method according to claim 19 wherein a filtering capacitive element is coupled between the output of the differential amplifier and a supply line.
